(19) United States
(12) Patent Application Publication
(10) Pub. No.: US 2015/0245599 A1
(43) Pub. Date: Sep. 3, 2015

(54) FISHING ROD WITH REEL RETRIEVER

(71) Applicants: Gary Edwards, Louisville, KY (US); Wayne Higdon, Louisville, KY (US)

(72) Inventors: Gary Edwards, Louisville, KY (US); Wayne Higdon, Louisville, KY (US)

(21) Appl. No.: 14/195,044

(22) Filed: Mar. 3, 2014

(51) Int. Cl. A01K 89/01; A01K 89/015; A01K 89/00; A01K 87/08; A01K 87/04; A01K 87/06

(52) U.S. Cl. CPC A01K 89/01; A01K 87/04; A01K 87/06; A01K 89/006; A01K 87/08; A01K 89/015

(57) ABSTRACT

A fishing rod with reel retriever comprising a fishing rod, where the fishing rod includes a handle, a ferrule extending from an end of the handle, and an eye at an end of the ferrule opposite to the handle, where the eye guides a line along the ferrule; and a reel retriever coupled to the handle of the fishing rod, where the reel retriever includes, a spool around which the line is wrapped, a hand crank incorporated into the spool, where the hand crank drives the spool, and a guide at a front portion of the reel retriever, where the guide directs the line into the spool to prevent tangles and knots.

### BACKGROUND OF THE INVENTION

1. Field of the Invention

The present invention relates to a fishing reel with incorporated with a reel and lure retriever to more easily reel in a line without tangles while fishing.

2. Description of Related Art

Fishing is a fun recreational and sporting activity enjoyed by many people. Some prefer to fish for pleasure while others fish for sport. Fishermen have their preferred methods to fish, but a few concepts are common to all; utilizing a hook and a line to snare a fish. Even though the basic concept is simple, the techniques used have transformed fishing into what some consider an art form, with a preferred style for everyone. Also, the type, size and weight of the fish sought can determine the length, weight, flexibility, and speed of the rod.

Even though many features are left to choice, a common problem encountered is a tangled line. Knots and tangles in the fishing line can cause frustration to an activity that many people use for relaxation. When a knot occurs, it is time consuming to unfasten it before the next use; causing more time fixing the rod, and less time actually catching fish. Often if the knot is too complex the line may snap or have to be cut resulting is replacement of the line and lure. After repeated line tangling fishing can become aggravating and costly. In light of the foregoing problem, it would be beneficial in the art to provide a fishing rod that prevents tangling to the line when reeling in a lure.

### SUMMARY OF THE INVENTION

In view of the foregoing disadvantages inherent in the prior art, the general purpose of the present invention is to provide a fishing rod incorporated with a reel retriever, configured to include all of the advantages of the prior art, and to overcome the drawbacks inherent therein.

Accordingly, an object of the present invention is to provide a fishing rod with a reel retriever to prevent knotting in the line while fishing.

To achieve the above objects, in an aspect of the present invention, a fishing rod with reel retriever is described comprising a fishing rod, where the fishing rod includes a handle, a ferrule extending from an end of the handle, and an eye at an end of the ferrule opposite to the handle, where the eye guides a line along the ferrule; and a reel retriever coupled to the handle of the fishing rod, where the reel retriever includes, a spool around which the line is wrapped, a hand crank incorporated into the spool, where the hand crank drives the spool, and a guide at a front portion of the reel retriever, where the guide directs the line into the spool to prevent tangles and knots.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a fishing rod with reel retriever in accordance with an exemplary embodiment of the present invention.

### DETAILED DESCRIPTION OF THE DRAWINGS

The present invention relates to a fishing reel with incorporated with a reel and lure retriever to more easily reel in a line without tangles while fishing. The present invention provides a fishing rod with reel retriever to retrieve a lure quickly and efficiently without tangles and with less physical pulling. The fishing rod with reel retriever includes a fishing rod with handle that is coupled with a reel retriever. Easy to use, simply cast the fishing line, and in the event the lure gets caught in underwater rubble, merely run the retriever down the fishing line to free the lure and use the hand reel to manually crank the retriever and lure back into the spool. This process ensures that the lure is retrieved quickly without tangles and with less physical pulling.

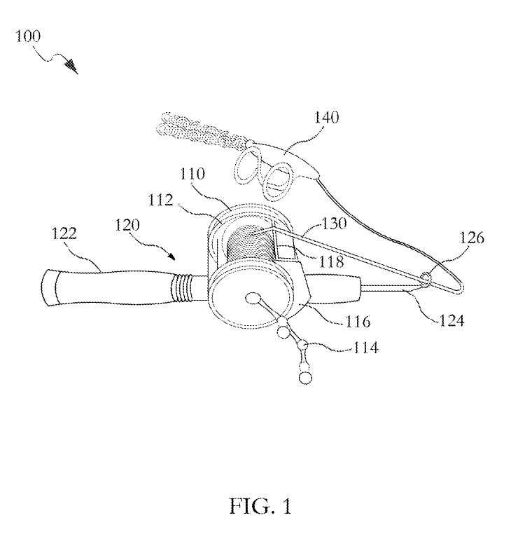

Turning now descriptively to the drawing, referring to FIG. 1, a perspective view of a fishing rod with reel retriever 100 is shown in accordance with an exemplary embodiment of the present invention. The fishing rod with reel retriever 100 includes a reel retriever 110 coupled to a fishing rod 120. The fishing rod 120 includes an ergonomic handle 122. The ergonomic handle 122 comfortably shapes to a user's hand, and may be further covered with a soft padding. Extending from the handle 122 is a ferrule 124 and an eye 126. The eye 126 guides a fishing line 130 towards the reel retriever 110. At an opposing end of the line 130 from the rod 120 is a lure 140. The ferrule 124 extends the length of the fishing rod 120 to end at the eye 126. The ferrule 124 may be short to include only one eye 126. The entire length of the rod 120 may be approximately 10-16 inches, preferably extending 12 inches.

The reel retriever 110 includes a spool 112 around which the fishing line 130 is wrapped. To wind the spool 112 a hand crank 114 is attached. The hand crank 114 may be adjustable to various angles for a customized grip within the user's hand. Further the hand crank 114 enables adjustment for better leverage when reeling in the line 130. At a front portion of the reel retriever 110 is a guide 116 to direct the line 130 into the spool 112. The guide 116 includes a lip 118 over which the line 130 travels before entering the reel retriever 110. The lip 118 ensures that the line 130 does not tangle or bunch when wrapping around the spool 112. During use, the hand crank 114 drives the spool to wind the line. The lure 140 keeps the line taut during reeling. By maintaining a taut line 130, the lip 118 wraps the line 130 in a naturally, orderly fashion to ensure that tangles and bunching does not occur.

The fishing rod with reel retriever 100 is an ideal tool to quickly and efficiently reel in a fishing lure 140. The hand crank 114 incorporated into the reel retriever 110 recovers the line 130 and lure 140 safely every time ensuring a tangle and knot-free fishing line. Therefore, the users are afforded peace of mind that even when in their line is caught in debris their line will reel in clean and efficient.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A fishing rod with reel retriever comprising:
a. a fishing rod, where the fishing rod includes:
i. a handle;
ii. a ferrule extending from an end of the handle; and
iii. an eye at an end of the ferrule opposite to the handle, where the eye guides a line along the ferrule; and
b. a reel retriever coupled to the handle of the fishing rod, where the reel retriever includes:
i. a spool around which the line is wrapped;
ii. a hand crank incorporated into the spool, where the hand crank drives the spool; and
iii. a guide at a front portion of the reel retriever, where the guide directs the line into the spool to prevent tangles and knots.

2. The fishing rod with reel retriever according to claim 1, where the guide includes a lip over which the line passes to enter the spool.

3. The fishing rod with reel retriever according to claim 1, where the fishing rod comprises a length of 12 inches.

4. The fishing rod with reel retriever according to claim 1, where the handle is ergonomic.

5. The fishing rod with reel retriever according to claim 1, where the handle is padded.

6. The fishing rod with reel retriever according to claim 1, where the hand crank is adjustable.
